(19) United States
(12) Patent Application Publication
(10) Pub. No.: US 2026/0007099 A1
(43) Pub. Date: Jan. 8, 2026

(54) AGRICULTURAL HEADER ADJUSTMENT FOR REDUCING MATERIAL STAGNATION

(71) Applicant: Deere & Company, Moline, IL (US)

(72) Inventors: SCOTT N. CLARK, Bettendorf, IA (US); DUANE M. BOMLENY, Geneseo, IL (US); SCOTT E. FAULKNER, Orion, IL (US)

(21) Appl. No.: 18/763,230

(22) Filed: Jul. 3, 2024

(51) Int. Cl. A01D 41/14; A01B 69/00

(52) U.S. Cl. CPC A01D 41/141; A01B 69/004

(57) ABSTRACT

An apparatus includes one or more processors and a non-transitory computer-readable storage medium. The non-transitory computer-readable storage medium is coupled to the one or more processors and stores programming instructions for execution by the one or more processors. The programming instructions instruct the one or more processors to adjust a machine attribute of an agricultural header to reduce material stagnation in the agricultural header.

### TECHNICAL FIELD

The present disclosure relates generally to an agricultural work machine having an agricultural header attached thereto.

### BACKGROUND

Some work machines, such as agricultural work machines (e.g., combine harvesters) are used in combination with an implement, such as an agricultural header, to perform work. The agricultural header may be arranged to be moved in a forward direction over a field. The agricultural header, such as a corn header, may have a laterally extending frame supporting a separating mechanism to separate a crop, such as corn, from a stalk. The header conveys the separated crop into the work machine.

### SUMMARY

During the separating and/or conveying of the crop, some crop stagnation or plugging may occur in the header. The disclosure provides a system that adjusts an agricultural header to improve feeding and crop gathering performance. In some examples, the system may adjust the header in response to detected or predicted material stagnation. In other examples, the system may adjust the header without detection or prediction.

In one aspect, the disclosure provides an apparatus including one or more processors and a non-transitory computer-readable storage medium. The non-transitory computer-readable storage medium is coupled to the one or more processors and stores programming instructions for execution by the one or more processors. The programming instructions instruct the one or more processors to steer an agricultural header in a weaving pattern to reduce material stagnation in the agricultural header.

In another aspect, the disclosure provides an apparatus including one or more processors and a non-transitory computer-readable storage medium. The non-transitory computer-readable storage medium is coupled to the one or more processors and stores programming instructions for execution by the one or more processors. The programming instructions instruct the one or more processors to: detect or predict material stagnation in a row unit of an agricultural header and adjust a machine attribute of the agricultural header in response to the detection or prediction of material stagnation.

In yet another aspect, the disclosure provides a material stagnation reduction system. The system includes an agricultural machine configured to move along a surface and an agricultural header connected to the agricultural machine and configured to harvest crop material as the agricultural header is moved along the surface by the agricultural machine. The agricultural header includes a frame supporting a plurality of row units. The system also includes one or more processors and a non-transitory computer-readable storage medium coupled to the one or more processors and storing programming instructions for execution by the one or more processors. The programming instructions instruct the one or more processors to: detect or predict material stagnation in at least one of the one or more row units and adjust a machine attribute of the agricultural header in response to the detection or prediction of material stagnation.

Additionally, the various aspects may include one or more of the features described below, alone or in any combination.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 is a side view of an agricultural machine having an agricultural header and a material stagnation reduction system in accordance with one implementation of the present disclosure.

FIG. 2 is a perspective view of the agricultural header of FIG. 1.

FIG. 3 is a top view of a row unit of the agricultural header of FIG. 1.

FIG. 4 is a bottom perspective view of the row unit of FIG. 3.

FIG. 5 is a block diagram of a controller associated with the agricultural machine and the agricultural header of FIG. 1.

FIG. 6 is a top view of the agricultural machine and the agricultural header of FIG. 1 in a field having rows of crop.

FIG. 7 is an enlarged view of a portion of FIG. 6 illustrating one example of steering for reducing material stagnation.

FIG. 8 is another enlarged view of the portion of FIG. 6 illustrating another example of steering for reducing material stagnation.

FIG. 9 is yet another enlarged view of the portion of FIG. 6 illustrating yet another example of steering for reducing material stagnation.

FIG. 10 is a system diagram illustrating the material stagnation reduction system of FIG. 1.

Like reference numerals are used to indicate like elements throughout the several figures.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, systems, or methods and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

The present disclosure may encompass automatically adjusting a machine attribute of the header to reduce crop stagnation in the header. The present disclosure is directed to systems and methods for adjusting an implement. In some examples, the implement may be adjusted based on detected or predicted material stagnation therein. For example, the present disclosure may be directed to adjusting an agricultural header in response to detected or predicted crop material stagnation therein. The present disclosure may encompass automatically adjusting a machine attribute of the header in response to detected or predicted material stagnation therein. In the example of a combine harvester and an agricultural header, the machine attribute may include any one of or any combination of: the position of the header with respect to a crop row (e.g., steering the combine harvester to adjust the position of the header with respect to the crop row), ground speed, header disposition, a component of the header (e.g., gathering chain speed, stalk roll speed, deckplate position, backshaft speed, auger speed, header transmission system state, etc.), or other machine attribute(s).

Words of orientation, such as “up,” “down,” “top,” “bottom,” “above,” “below,” “leading,” “trailing,” “front,” “back,” “forward,” “rearward,” “fore,” “aft,” “left,” “right,” “lateral,” and the like, are used in the context of the illustrated examples as would be understood by one skilled in the art and are not intended to be limiting to the disclosure. For example, for a particular type of vehicle in a conventional configuration and orientation, one skilled in the art would understand these terms as the terms apply to the particular vehicle.

For example, the term “forward” (and the like) corresponds to a forward direction of travel of a header or combine harvester, such as during a harvesting operation. Likewise, the term “rearward” (and the like) corresponds to a direction opposite the forward direction of travel. In this regard, for example, a “forward facing” feature on a header may generally face in the direction that the header travels during normal operation, while a “rearward facing” feature may generally face opposite that direction. The terms “left” and “right” (and the like) are to be understood with respect to the forward direction of travel, as would be viewed by an operator in the operator cab facing forward.

Also as used herein, with respect to a header (or components thereof), unless otherwise defined or limited, the term “leading” (and the like) indicates a direction of travel of the header during normal operation (e.g., the forward direction of travel of a harvester vehicle carrying a header). Similarly, the term “trailing” (and the like) indicates a direction that is opposite the leading direction. In this regard, for example, a “leading” edge of a header may be generally disposed at the front of the header, with respect to the direction travel of the header during normal operation (e.g., as carried by a combine harvester). Likewise, a “trailing” edge of a header may be generally disposed at the back of the header opposite the leading edge, with respect to the direction of travel of the header during normal operation.

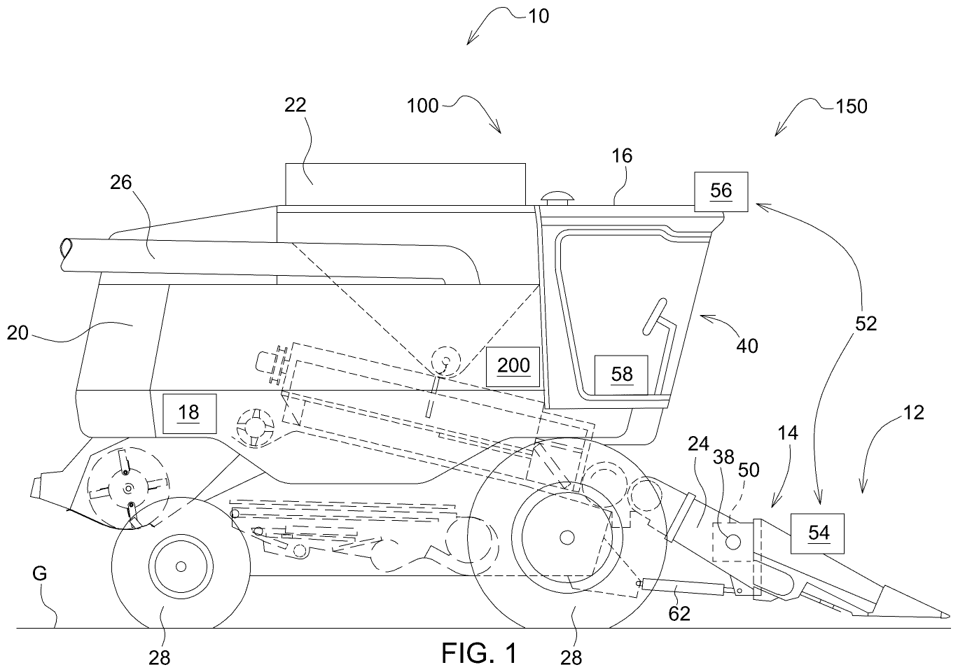

FIG. 1 is a perspective view of an example agricultural machine 10 (which may be referred to herein as a “combine harvester 10” as one example) with an implement 12 (which may be referred to herein as “a header 12” as one example) attached thereto at a forward end 14. The combine harvester 10 may include an operator cab 16, a power source 18 disposed within a body 20 of the combine harvester 10, a clean grain bin 22, a feeder house 24 to which the header 12 attaches, an unloader 26, and a plurality of ground engaging components 28 (such as wheels or tracks) that transport the combine harvester 10 along the ground G. The power source 18 may drive the combine harvester 10 along the ground G at a ground speed. The combine harvester 10 may also include a steering system 40 for controlling the direction of travel, or heading, of the combine harvester 10 and the header 12. The steering system 40 may have any suitable set of components and may be controlled by an operator (e.g., via a steering wheel), by a control system 100, or a combination of both. An actuator system 62 may control a disposition 228 (e.g., height and/or tilt) of the header 12 with respect to the ground G.

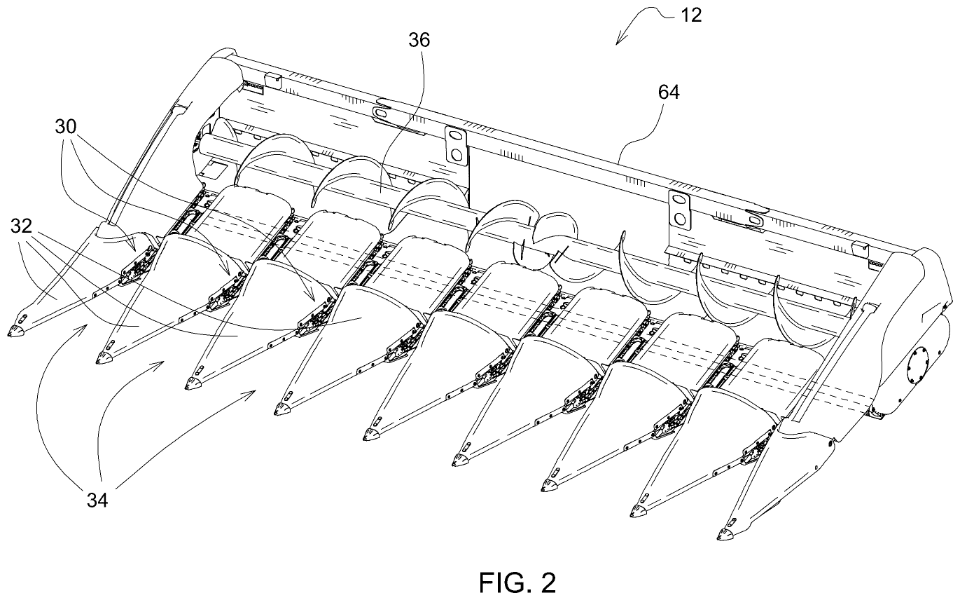

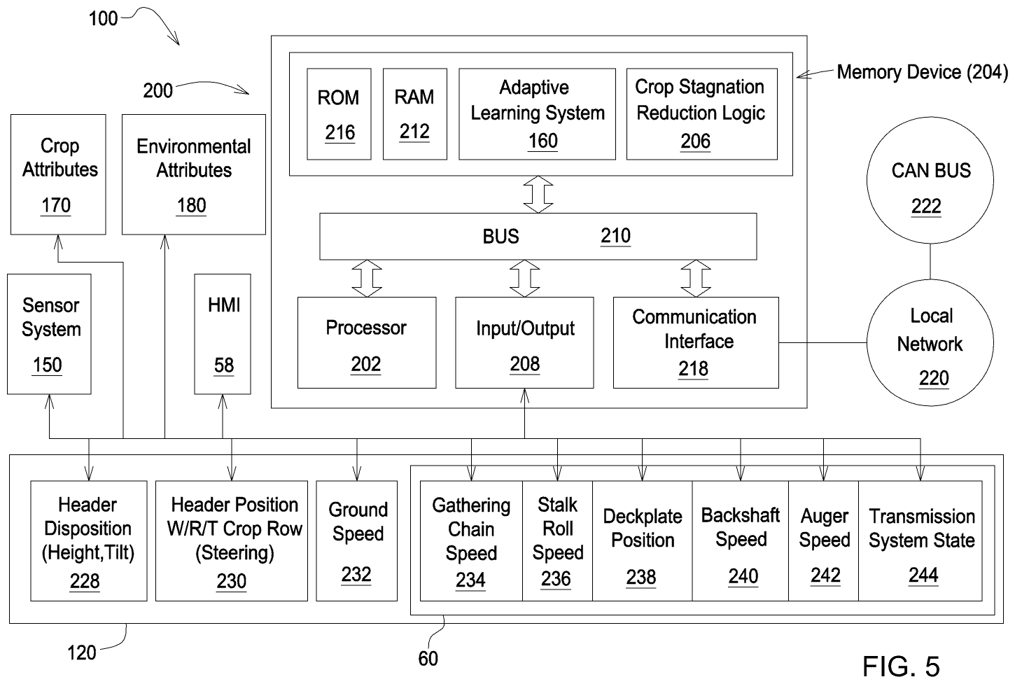

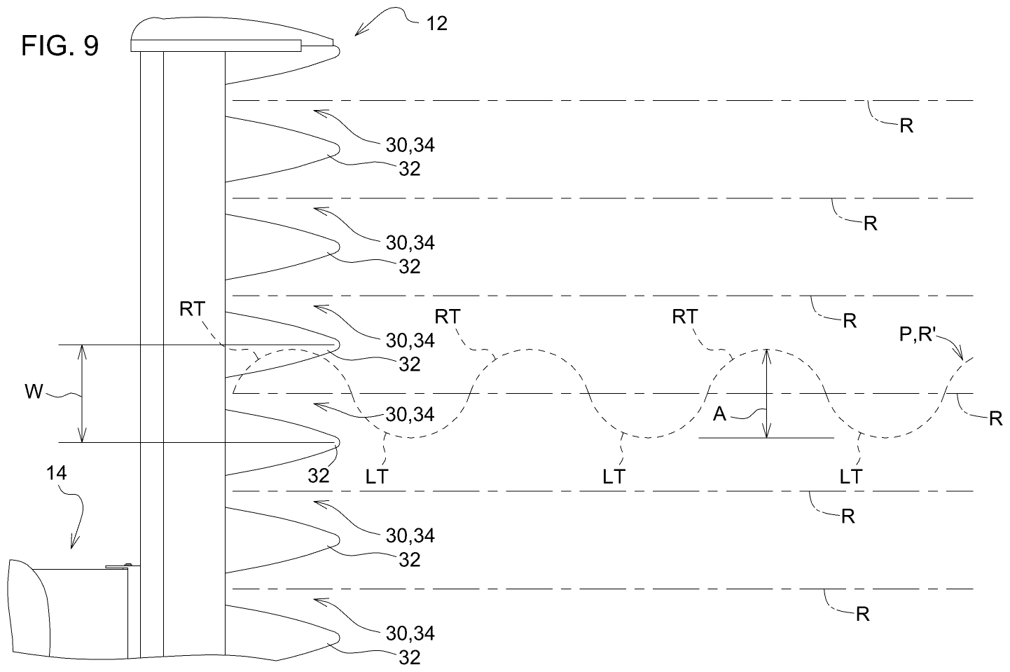

As best illustrated in FIG. 2, the header 12 may be in the form of a crop header that includes a plurality of row units 30 arranged one after the other in a lateral direction along a frame 64 the header 12. The row units 30 may be supported by the frame 64. The row units 30 are used to engage crop and separate the crop. The crop may include any crop planted in rows R (FIG. 5), such as corn or other grains, sugarcane, etc. In the illustrated example, corn is used although it should be understood that the disclosure may be employed for other crops. The header 12 also includes crop dividers 32 located between directly adjacent row units 30 that direct crop stalks into slots 34 defined by each of the row units 30. Each row unit 30 has a width W (FIG. 9) defined as the spacing between directly adjacent crop dividers 32 perpendicular to the forward direction of travel, which are configured to direct stalks within the width W into the respective row unit 30. The header 12 also includes an auger 36 downstream of the row units 30. The auger 36 operates to direct separated crop, such as corn ears, to a central location along the header 12 from where the corn ears are directed into the combine harvester 10, such as for further processing. A speed 242 of the auger 36 may be adjustable and may be controlled mechanically, hydraulically, and/or electrically.

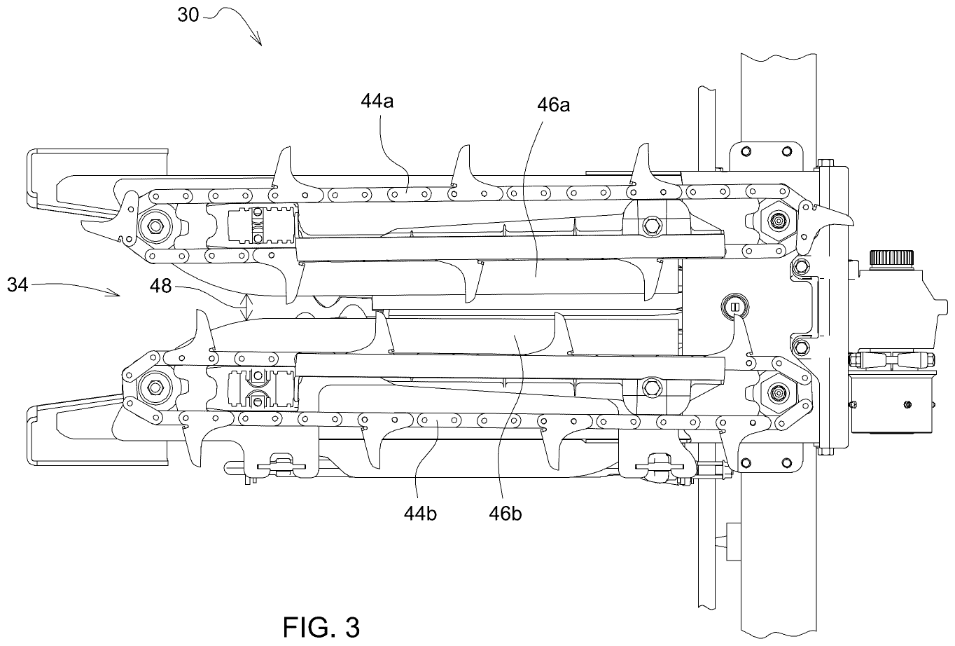

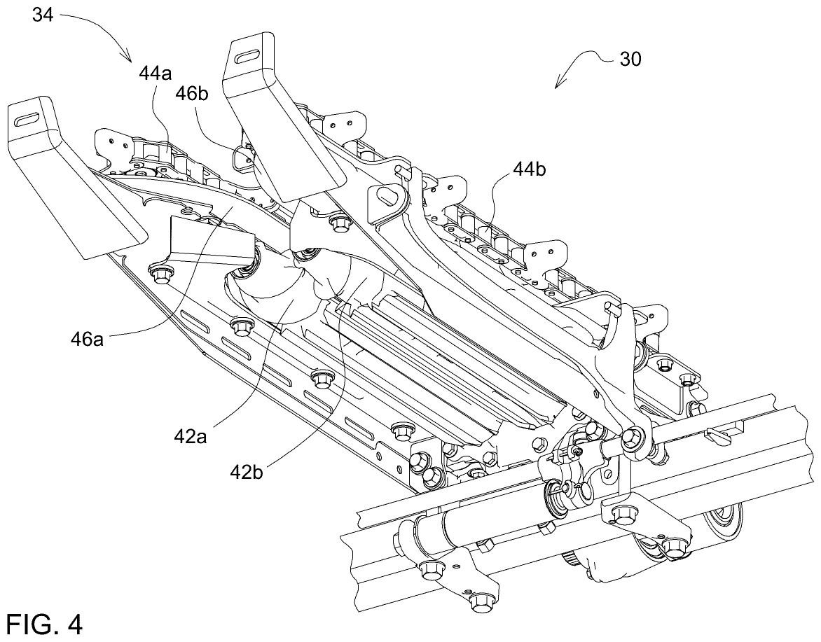

FIGS. 3-4 illustrate one of the row units 30. It should be understood that all of the row units 30 are essentially the same and need not be described separately. The row unit 30 may include a pair of stalk rolls 42a, 42b, a pair of gathering chains 44a, 44b, and a pair of deck plates 46a, 46b. The slot 34 is defined between the stalk rolls 42a, 42b, between the gathering chains 44a, 44b, and/or between the deck plates 46a, 46b. The pair of gathering chains 44a, 44b draw the crop stalk into the slot 34. The pair of stalk rolls 42a, 42b pull each stalk downward toward the pair of deck plates 46a, 46b, whereupon a corn ear contacts one or both of the deck plates 46a, 46b to separate the corn ear from the stalk. A gap 48 between the deck plates 46a, 46b may be adjustable and may be controlled mechanically, hydraulically, and/or electrically by adjusting the position 238 of one or both of the deck plates 46a, 46b. A speed 234 of the pair of gathering chains 44a, 44b may be adjustable and may be controlled mechanically, hydraulically, and/or electrically. A speed 236 of the stalk rolls 42a, 42b may be adjustable may be controlled mechanically, hydraulically, and/or electrically.

Components 60 of the header 12 may include, but are not limited to, the auger 36, at least one of the stalk rolls 42a, 42b, at least one of the gathering chains 44a, 44b, and/or at least one of the deck plates 46a, 46b. The components 60 of the header 12 may be powered mechanically, hydraulically, and/or electrically (singly or in any combination). As one example, the combine harvester 10 may drive some or all of the components 60 of the header 12 by driving a rotatable power shaft of the header 12, which may be referred to as a backshaft 38 (FIG. 1). Some or all of the components 60 of the header 12 may be powered mechanically by the backshaft 38, e.g., via a transmission system 50. The transmission system 50 may include any suitable structure. For example, the transmission system 50 may include one or more shafts, belts, linkages, gears, and/or clutches, etc. configurable in different states to provide different speeds or positions to different components 60. Some or all of the components 60 may be controllable (e.g., for speed or position) by controlling the transmission 50. Additionally or alternatively, some or all of the components 60 may be controllable (e.g., for speed or position) by controlling the drive speed 240 of the backshaft 38.

The harvester 10 may also include a human-machine interface (HMI) 58 (e.g., including a display and input members, such as any combination of one or more of buttons, dials, joysticks, mouse pads, a touch screen, a graphical user interface, or the like) with which the operator can input settings, preferences, commands, etc. to control various aspects of the harvester 10 and/or the header 12. The operator inputs are communicated to a control system 100 by wired or wireless signals. As another example, the HMI 58 may include a mobile device, such as a smart phone or tablet.

Returning to FIG. 1, the combine harvester 10 may include a sensor system 150 detecting material stagnation in the header 12. More specifically, the sensor system 150 senses material stagnation within one or more of the row units 30. Crop material may stagnate and may form a bridge from one crop divider 32 towards a directly adjacent crop divider 32. The sensor system 150 may include one or more sensors 52. The one or more sensors 52 may include one or more contact sensors 54 and/or one or more non-contact sensors 56.

For example, the contact sensor 54 may include one or more pressure sensors, one or more force sensors, one or more proximity sensors, etc. The contact sensor 54 may include a potentiometer for converting a physical position of the contact sensor 54, which may be moved or pressurized by the presence of stagnated material, into a voltage signal. As another example, the contact sensor 54 may include an electrical sensor (e.g., a voltage sensor, current sensor, resistance sensor, etc.) detecting debris forming a bridge between two directly adjacent crop dividers 32 by measuring an electrical connection between the two directly adjacent crop dividers 32 through the stagnated material. As another example, the contact sensor 54 may include a spring-loaded rod. The contact sensor 54 may be mounted, as one example, to one or more of the row units 30. More specifically, the contact sensor 54 may be mounted to one or more of the crop dividers 32.

For example, the non-contact sensor 56 may include one or more sensors transforming any frequency or wavelength into an electronic signal. For example, the non-contact sensor 56 may include one or more cameras. The camera(s) may have a single lens, two lenses (e.g., a stereo camera), or more lenses. The non-contact sensor 56 may include a structured light camera, a RGB (red green blue) camera, a radar emitter and detector, a lidar (e.g., laser) emitter and detector, an ultrasonic sensor, a time of flight (ToF) sensor, a thermal camera, etc. The non-contact sensor 56 may be mounted in any suitable location on the header 12 or the combine harvester 10. For example, the non-contact sensor 56 may be mounted to “see” the tops of the crop dividers 32 and may include one, two, or more sensors of the same or different types in cooperation with each other. As one example, the non-contact sensor 56 may be mounted to the operator cab 16 of the combine harvester 10, overlooking the row units 30. As another example, the non-contact sensor(s) 56 may be mounted to one or more of the row units 30. For example, a radar emitter and receiver may be mounted across from each other on opposite sides of a row unit 30 to detect when stagnating material breaks the signal therebetween. Alternatively, a laser and receiver may employed in a similar fashion.

The control system 100 (which may also be referred to herein as a material stagnation reduction system 100) may include a controller 200, such as a microprocessor-based electronic control unit or the like, receiving signals from the sensor system 150 and sending signals to control one or more machine attributes 120 of the header 12. Signals, as used herein, may include wired electronic signals (e.g., by circuit or wire), wireless electronic signals (e.g., by satellite, internet, mobile telecommunications technology, a frequency, a wavelength, Bluetooth), or the like.

The controller 200 may include a bus 210 or other communication mechanism for communicating information and one or more processors 202 coupled with the bus 210 for processing information. The controller 200 includes a memory 204 (which may also be referred to herein as a non-transitory computer-readable storage medium 204), which may comprise random access memory (RAM) 212 or other dynamic storage devices for storing information and programming instructions encoded thereon, such as crop stagnation reduction logic 206 to be executed by the processor 202, and/or read only memory (ROM) 216 or other static storage device for storing static information and instructions for the processor 202. In other implementations, it may be possible to encode the crop stagnation reduction logic 206 on a static storage device such as the ROM 216. The memory 204 may be a tangible non-transitory, non-volatile memory device and operable to store information and instructions executable by the processor 202. The controller 200 may also include an input/output 208 for receiving input signals and providing output signals. Additionally, the controller 200 and, in particular a communication interface 218 of the controller 200, may be operatively coupled to a local network 220 and/or a CAN bus 222. The term “controller” as used herein may encompass a single controller or a group of controllers in communication with each other and may be located onboard, offboard, or a combination of both.

The crop stagnation reduction logic 206 automatically makes adjustments to the header 12 for improving the flow of crop through the header 12 and reducing the stagnation of crop in the header 12.

The control system 100, best illustrated in FIG. 5, may adjust a machine attribute 120 of the header 12. The machine attribute 120 may include any one or more of: a disposition 228 of the header 12 (e.g., height above the ground, tilt, etc.), a position 230 of the header 12 with respect to a crop row R (e.g., by steering the combine harvester via the steering system 40 to adjust the position of the header 12 with respect to the crop row R), ground speed 232, one or more of the components 60 of the header 12 (e.g., gathering chain speed 234, stalk roll speed 236, deckplate position 238, backshaft speed 240, auger speed 242, etc.), or other machine attribute(s).

The crop stagnation reduction logic 206 may adjust the machine attribute 120 in response to detected or predicted material stagnation therein. A signal representative of detected or predicted material stagnation may be provided by the sensor system 150, determined by the crop stagnation reduction logic 206, determined by a proactive adjustment system 160, or a combination of one or more of the above. For example, the sensor system 150 may sense material stagnation with one or more of the sensors 52. The crop stagnation reduction logic 206 may analyze the sensor signal(s) and determine when material stagnation is sensed. As another example, the crop stagnation reduction logic 206 may analyze the signal(s) from the sensor system 150 and determine that material stagnation is predicted. Either the detected or predicted material stagnation may trigger the adjustment of the machine attribute 120 for reducing or inhibiting the crop stagnation. Examples of adjustments to machine attributes 120 are described in greater detail below.

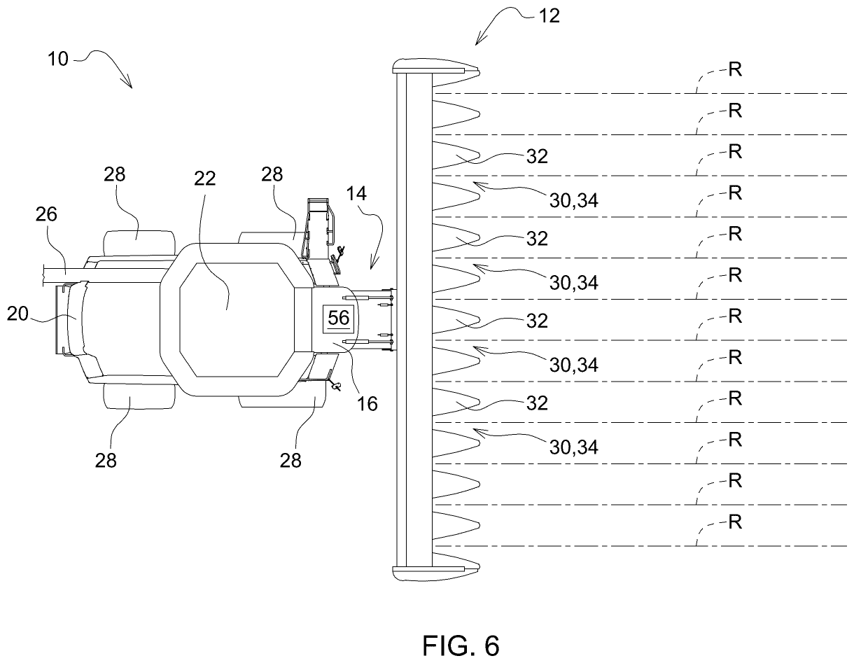

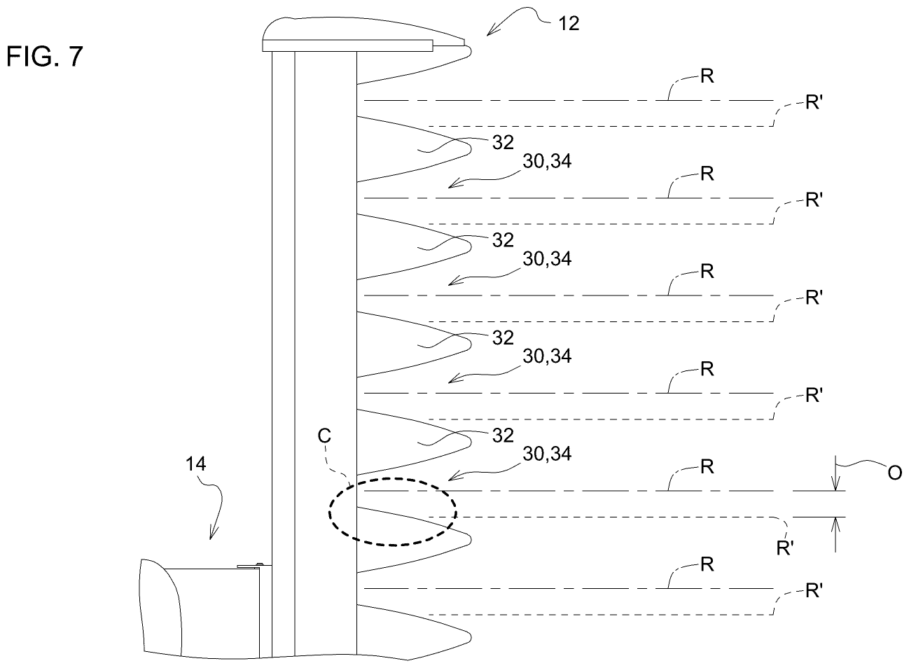

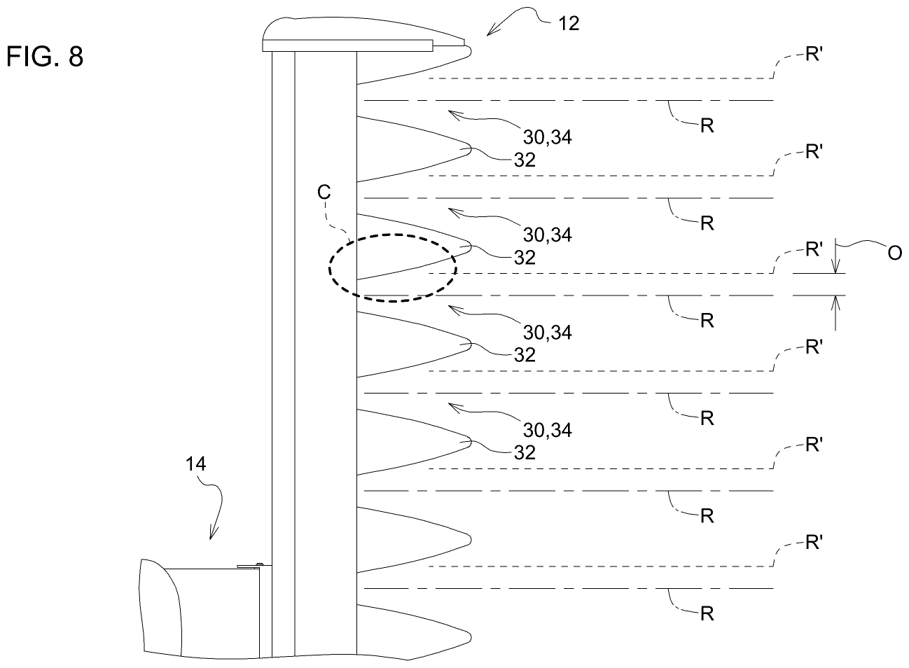

FIG. 6 illustrates a plan view of the field showing the top of the combine harvester 10 and the rows R of crop centered within each row unit 30. The header 12 may typically (e.g., as a baseline) be steered such that each row R is centered in its respective row unit 30. However, steering the combine harvester 10, at least temporarily, such that each row R is off-center with respect to its respective row unit 30, which is counterintuitive, may improve flow and reduce material stagnation. FIGS. 7 and 8 illustrate phantom rows R′ depicting the modified position of the row R after a steering adjustment. The row R′ may be offset within the row unit 30 by an offset distance O. The offset distance O of the row R is large enough that the stalks of crop act to sweep the stagnated material back into the flow but small enough that the ears can still be separated from the stalks. As such, the crop stagnation reduction logic 206 may control the steering system 40 to adjust the position of the header 12 with respect to the rows R such that each row R is off-center in its respective row unit 30 (see R′). Such deviation from centered can be achieved in a variety of different ways and may occur for any desired duration of time. For example, the header 12 may be steered left such that each row R of stalks enters the respective row unit 30 closer to the right crop divider 32 (as illustrated in FIG. 7 with phantom row R′ depicting the modified position of the row R after the steering adjustment) or steered right such that each row R of stalks enters the respective row unit 30 closer to the left crop divider 32 (as illustrated in FIG. 8 with phantom row R′ depicting the modified position of the row R after the steering adjustment).

In some implementations, as illustrated in FIG. 9, the header 12 may be steered in a repeated weaving pattern P of left and right, left and right, etc. The weaving pattern P includes at least one right turn RT and at least one left turn LT in immediate succession, which may be referred to as a left-and-right-turn pair. The weaving pattern P may repeat each left-and-right-turn pair one time, two times, three times, four times, five times, six times, etc., or more, in immediate succession. Each left turn LT in the weaving pattern P brings the row R off-center to the right, as illustrated with phantom row R′ at LT depicting the modified position of the row R after the left turn steering adjustment. And, each right turn RT in the weaving pattern P brings the row R off-center to the left, as illustrated with phantom row R′ at RT depicting the modified position of the row R after the right turn steering adjustment. The weaving pattern P has an amplitude A that is less than the width W of the row unit 30 to keep each row R of crop flowing into its respective row unit 30 (without flowing into an adjacent row unit 30). In other words, the amplitude A of the weaving pattern is small enough to keep each row R of crop dedicated to its respective row unit 30 but alternates the off-centeredness of the row R between left and right sides within the row unit 30. Weaving left and right may address stagnation on both sides or the row unit 30 without the need for detection or prediction of stagnation. As such, the crop stagnation reduction logic 206 may automatically steer the header 12 in the weaving pattern P (FIG. 9) periodically (or continuously in some implementations) as a proactive stagnation-reduction method. For example, the crop stagnation reduction logic 206 may steer the agricultural header in the weaving pattern for a predetermined period of time periodically during a harvesting operation. Alternatively, the weaving pattern P may be automatically steered in response to detected or predicted crop stagnation until the crop stagnation is no longer detected or for a predetermined period of time.

In some implementations, the crop stagnation reduction logic 206 adjusts the position 230 of the header 12 based on a side (i.e., left or right) of the row unit 30 on which the crop stagnation is detected or predicted. Stagnating crop C is illustrated in FIGS. 7 and 8. For example, if crop stagnation C is detected or predicted on the right side of the row unit 30 (FIG. 7), then the header 12 may be steered left, and if crop stagnation C is detected or predicted on the left side of the row unit 30 (FIG. 8), then the header 12 may be steered right. The weaving pattern P between left and right may address stagnation on both sides without the need for specific detection of a side of stagnation. Weaving is also advantageous when the stagnation occurs on both sides; as such, it is also possible for the weaving pattern P to be triggered by the detection or prediction of crop stagnation on both the left and right sides of a row unit 30. In some implementations, the weaving pattern P may be steered in response to detected or predicted crop stagnation without regard to the side on which the crop stagnation is detected or predicted.

Additionally or alternatively, the crop stagnation reduction logic 206 may control the power source 18 to adjust the ground speed 232 of the header 12. The ground speed 232 may be increased or decreased. In some examples, the ground speed 232 may be increased while the position 230 of the header 12 with respect to the rows R is adjusted. For example, the ground speed 232 may be increased when the header 12 is steered such that each row R is off-center with respect to its respective row unit 30.

Additionally or alternatively, the crop stagnation reduction logic 206 may adjust the disposition 228 of the header 12. This may include height above the ground G, and/or tilt with respect to a horizontal plane of the ground G, etc. The tilt direction may include fore, aft, lateral, etc. as would be understood by one of ordinary skill in the art with respect to the travel direction of the combine harvester 10. The disposition 228 of the header 12 may be adjusted via the actuator system 62, or any other suitable mechanism.

The crop stagnation reduction logic 206 may end the adjustments and return to baseline operation (e.g., baseline speeds, baseline position, baseline steering direction, etc.) when material stagnation is no longer detected or predicted.

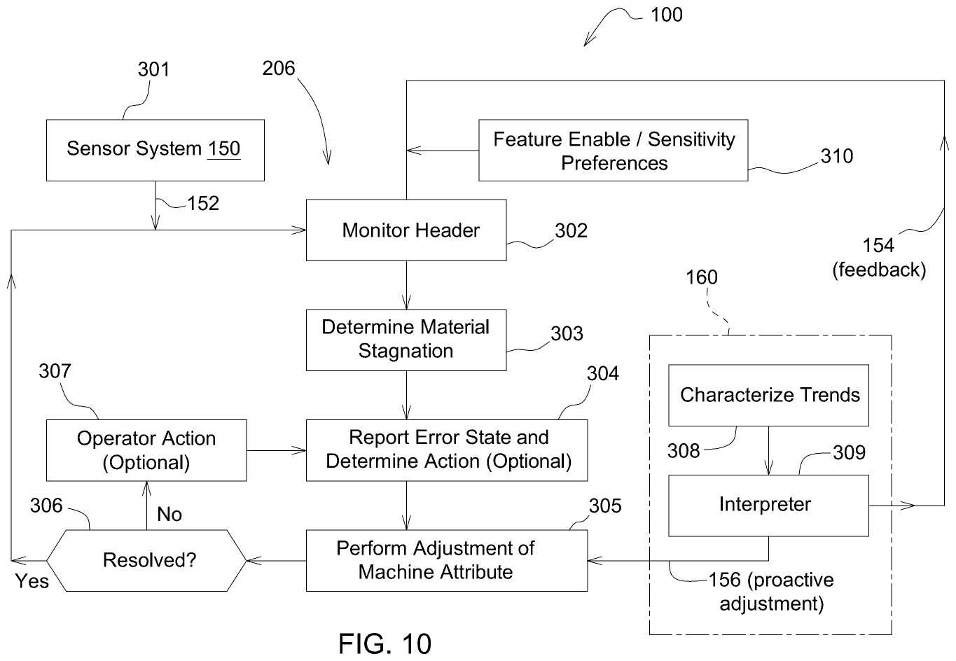

FIG. 10 illustrates a flow chart system diagram of the control system 100 including the crop stagnation reduction logic 206, or a method(s) executed by the control system 100. Though steps may be described in a certain order herein, the steps may be performed in other suitable orders, some combinations of steps may be performed at the same time, and one or more steps may be omitted. Additional steps are apparent from the disclosure of the crop stagnation reduction logic 206 above.

At step 301, the sensor system 150 may provide material measurement signals 152 to the control system 100. More specifically, the material measurement signals 152 may be provided to the crop stagnation reduction logic 206. At step 302, the crop stagnation reduction logic 206 may monitor the flow of material in the header 12, e.g., by receiving the material measurement signals 152. At step 303, the crop stagnation reduction logic 206 may analyze the flow of material in the header 12 and determine whether material stagnation is imminent or present, e.g., by processing the material measurement signals 152 and/or by processing prediction feedback signals 154 from a proactive adjustment system 160 (which will be described in greater detail below). If stagnation is determined, at step 304 the crop stagnation reduction logic 206 may report the error state (e.g., report that material stagnation has been determined). Step 304 may be omitted in some implementations. The report may be in the form of a message to the operator in any suitable fashion. For example, the report may be communicated to the operator via the HMI 58, e.g., on a display in the operator cab 16 and/or to a mobile device, such as a smart phone or tablet. In some examples, the report may request input from the operator to determine action, e.g., to determine whether to move to step 305. At step 305, the crop stagnation reduction logic 206 performs adjustment of one or more of the machine attributes 120. At step 306, the crop stagnation reduction logic 206 determines whether the stagnation has been resolved (e.g., whether the stagnated material has re-entered the flow through the header 12). The determination may be made by further monitoring and analyzing the flow of material based on the material measurement signals 152. If the stagnation has been resolved (YES at step 306), then monitoring of the header 12 continues, returning to step 302. If the stagnation has not been resolved (NO at step 306), then the crop stagnation reduction logic 206 returns to step 305, sometimes via step 304 if employed. If the stagnation has not been resolved (NO at step 306), and before returning to step 304 and/or step 305, an opportunity may be given to the operator to take action at step 307. For example, the operator may take manual action to resolve the stagnation, if desired. At step 307, the ground speed of the harvester 10 may be reduced to zero to allow the operator to get out of the operator cab 16 and take manual action, such as sweeping the stagnated material. In some examples, step 307 may be omitted.

With further reference to FIG. 10, the control system 100 may also include the proactive adjustment system 160 for predicting material stagnation. The proactive adjustment system 160 may be any suitable type of machine learning system, such as generative artificial intelligence (generative AI), a trained model (e.g., a deep neural network trained on large amounts of data), and/or a trend-recognition system configured to analyze current and historical data to predict when material stagnation may be imminent. For example, current and/or historical crop attributes 170 and/or environmental attributes 180 may be tracked within a geospatial coordinate system. At step 308, the proactive adjustment system 160 may use machine learning to characterize trends. For example, historical material stagnation data (including historical crop attributes 170 and historical environmental attributes 180) may be analyzed by the proactive adjustment system 160 to characterize trends. At step 309, the proactive adjustment system 160 may monitor and analyze the current crop attributes 170 and/or the environmental attributes 180 to predict when material stagnation is imminent. The output at step 309, which may be in the form of the prediction feedback signal 154 and/or a proactive adjustment signal 156, is an interpretation of whether or not material stagnation is predicted based on the characterized trends. This interpretation, outputted by the proactive adjustment system 160, may be inputted into the crop stagnation reduction logic 206. As one example, the prediction feedback signal 154 is fed to the crop stagnation reduction logic 206 to be considered during header monitoring at step 302. The crop stagnation reduction logic 206 may use the material measurement signal 152, the prediction feedback signal 154, or a combination of both to monitor the header (at step 302) and determine material stagnation (at step 303). Additionally or alternatively, the crop stagnation reduction logic 206 may use the proactive adjustment signal 156 as a trigger to perform automatic adjustment of machine attributes 120 (at step 305). For example, when material stagnation is predicted by the proactive adjustment system 160, adjustment of the machine attribute(s) 120 at step 305 may be initiated by the crop stagnation reduction logic 206.

The crop attributes 170 may include any one of or any combination of: crop type, crop variety, crop moisture content, crop height, stalk content, leaf matter, planting data, crop posture (standing upright, bending over, etc.), crop health, crop population, crop yield, crop mechanics (brittle, tough, etc.), stalk size, ear height, ear size, crop damage (pest, disease, etc.), etc. The environmental attributes 180 may include any one of or any combination of: temperature, humidity, dew point, precipitation, wind, weed presence, and/or other environmental conditions.

An input 310, which may be omitted in some implementations, may allow an operator to enable and/or disable the crop stagnation reduction logic 206. When enabled, the machine attribute 120 may be adjusted by the control system 100 to reduce crop stagnation. When disabled, no automatic crop stagnation reduction will occur. The input 310 may also allow the operator to input sensitivity preferences for the crop stagnation reduction logic 206. As one example, the operator may adjust a threshold amount of detected material stagnation that triggers machine attribute adjustment. As another example, the operator may adjust a probability threshold of predicted material stagnation that triggers machine attribute adjustment.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. An apparatus comprising:
one or more processors;
a non-transitory computer-readable storage medium coupled to the one or more processors and storing programming instructions for execution by the one or more processors, the programming instructions instruct the one or more processors to:
steer an agricultural header in a weaving pattern to reduce material stagnation in the agricultural header.

2. The apparatus of claim 1, wherein the agricultural header includes a frame supporting a plurality of row units, each of the row units having a width defined between directly adjacent crop dividers perpendicular to a direction of travel, the weaving pattern instructed by the programming instructions having an amplitude less than the width of the row unit.

3. The apparatus of claim 2, wherein a row of crop is off-center within one of the plurality of row units to both left and right sides of the one of the plurality of row units during execution of the weaving pattern.

4. The apparatus of claim 1, wherein the weaving pattern instructed by the programming instructions includes at least one left-and-right-turn pair executed in immediate succession.

5. The apparatus of claim 1, wherein the weaving pattern instructed by the programming instructions includes at least two left-and-right-turn pairs executed in immediate succession.

6. The apparatus of claim 1, wherein the programming instructions further instruct the one or more processors to:
detect or predict material stagnation in the agricultural header; and
steer the agricultural header in the weaving pattern in response to the detection or prediction of material stagnation.

7. The apparatus of claim 1, wherein the programming instructions further instruct the one or more processors to steer the agricultural header in the weaving pattern for a predetermined period of time periodically during a harvesting operation for proactive material stagnation reduction.

8. An apparatus comprising:
one or more processors;
a non-transitory computer-readable storage medium coupled to the one or more processors and storing programming instructions for execution by the one or more processors, the programming instructions instruct the one or more processors to:
detect or predict material stagnation in a row unit of an agricultural header; and
adjust a machine attribute of the agricultural header in response to the detection or prediction of material stagnation.

9. The apparatus of claim 8, wherein the machine attribute includes any one of or any combination of: a steered position of the agricultural header with respect to a crop row, a ground speed, a header height, a header tilt, a gathering chain speed, a stalk roll speed, a deckplate position, a backshaft speed, an auger speed, or a header transmission system state.

10. The apparatus of claim 8, further comprising:
a sensor system detecting material stagnation in the row unit, wherein the sensor system includes one or both of a contact sensor or a non-contact sensor.

11. The apparatus of claim 10, wherein the contact sensor includes one of or any combination of: a pressure sensor, a force sensor, a proximity sensor, a potentiometer, an electrical sensor, or a spring-loaded rod.

12. The apparatus of claim 10, wherein the non-contact sensor includes any one or of any combination of: a structured light camera, a RGB camera, a radar emitter and detector, a lidar emitter and detector, an ultrasonic sensor, a ToF sensor, or a thermal camera.

13. The apparatus of claim 8, further comprising a machine learning system, wherein the programming instructions use the machine learning system to predict material stagnation.

14. The apparatus of claim 13, wherein the machine learning system analyzes crop attributes, environmental attributes, or both to predict material stagnation.

15. A material stagnation reduction system comprising:
an agricultural machine configured to move along a surface;
an agricultural header connected to the agricultural machine and configured to harvest crop material as the agricultural header is moved along the surface by the agricultural machine, the agricultural header comprising a frame supporting a plurality of row units;
one or more processors;
a non-transitory computer-readable storage medium coupled to the one or more processors and storing programming instructions for execution by the one or more processors, the programming instructions instruct the one or more processors to:
detect or predict material stagnation in at least one of the one or more row units; and
adjust a machine attribute of the agricultural header in response to the detection or prediction of material stagnation.

16. The material stagnation reduction system of claim 15, wherein the machine attribute includes any one of or any combination of: a steered position of the agricultural header with respect to a crop row, a ground speed, a header height, a header tilt, a gathering chain speed, a stalk roll speed, a deckplate position, a backshaft speed, an auger speed, or a header transmission system state.

17. The material stagnation reduction system of claim 15, further comprising:
a sensor system detecting material stagnation in the row unit, wherein the sensor system includes one or both of a contact sensor or a non-contact sensor.

18. The material stagnation reduction system of claim 17, wherein the contact sensor includes one of or any combination of: a pressure sensor, a force sensor, a proximity sensor, a potentiometer, an electrical sensor, or a spring-loaded rod.

19. The material stagnation reduction system of claim 17, wherein the non-contact sensor includes any one or of any combination of: a structured light camera, a RGB camera, a radar camera, a lidar camera, an ultrasonic camera, a ToF camera, a thermal camera, a radar emitter and receiver, or a laser emitter and receiver.

20. The material stagnation reduction system of claim 15, further comprising a machine learning system, wherein the programming instructions use the machine learning system to predict material stagnation.

21. The material stagnation reduction system of claim 20, wherein the machine learning system analyzes crop attributes, environmental attributes, or both to predict material stagnation.
